(19) United States
(12) Patent Application Publication
(10) Pub. No.: US 2013/0219504 A1
(43) Pub. Date: Aug. 22, 2013

(54) Method, System and Program Product for Document Verification

(71) Applicant: David Benjamin Mosier, Clearfield, UT (US)

(72) Inventor: David Benjamin Mosier, Clearfield, UT (US)

(73) Assignee: MM Technologies, LLC, Clearfield, UT (US)

(21) Appl. No.: 13/399,685

(22) Filed: Feb. 17, 2012

(51) Int. Cl. G06F 21/00

(52) U.S. Cl. 726/26

(57) ABSTRACT

A method, system and program product comprise processing a document using a key to generate a document identification. A matrix is generated using data from the document identification. The matrix comprises a scannable element. The matrix and the document are combined to form a second document in which a verification of an authenticity of the second document is performed using at least the matrix.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to systems for security. More particularly, one or more embodiments of the invention relate to systems for electronic document verification.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Government and private entities have a need for creating secure documents that are difficult to reproduce and provide capability for verification and authentication.

These governmental and private entity documents are used for verification associated with a multiplicity of applications such as verification of age, citizenship and education.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example online document creator system, in accordance with an embodiment of the present invention;

FIG. 2 illustrates an example online document verifier system, in accordance with an embodiment of the present invention;

FIG. 3 illustrates an example document creator system for use with offline verification, in accordance with an embodiment of the present invention;

FIG. 4 illustrates an example offline document verifier system, in accordance with an embodiment of the present invention;

FIG. 5 illustrates an example document, in accordance with an embodiment of the present invention;

FIG. 6 illustrates a block diagram depicting a conventional client/server communication system;

FIG. 7 illustrates an example method for online document creation as described with reference to FIG. 1, in accordance with an embodiment of the present invention;

FIG. 8 illustrates an example method for online document verification as described with reference to FIG. 2, in accordance with an embodiment of the present invention;

FIG. 9 illustrates an example method for document creation for offline verification as described with reference to FIG. 3, in accordance with an embodiment of the present invention;

FIG. 10 illustrates an example method for offline document verification as described with reference to FIG. 4, in accordance with an embodiment of the present invention; and

FIG. 11 illustrates a typical computer system that, when appropriately configured or designed, may serve as a computer system for which the present invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

Embodiments of the present invention will be described which provide means and methods for systems for generating a secure identification key that is resistant to brute force database attacks and is unique per an associated document.

System provides secure identification and retrieval of information for verification purposes. Furthermore, system provides configuration for varying levels of access. As non-limiting examples, levels of access may be configured for free public access and/or private access.

System provides presentation of information resistant to improper misappropriation of the associated information.

System provides capability for online and/or offline verification.

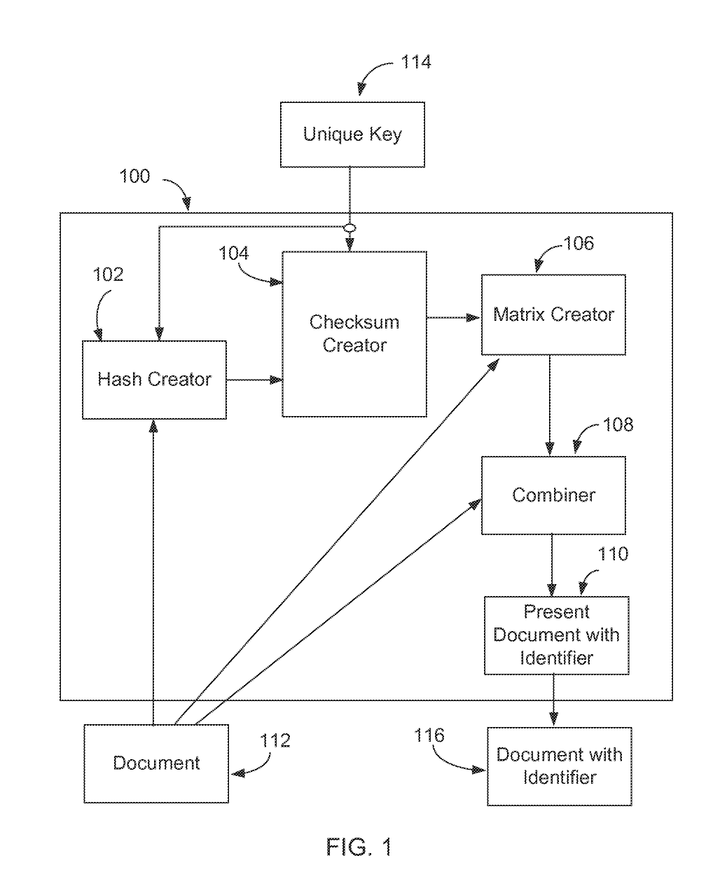

FIG. 1 illustrates an example online document creator system, in accordance with an embodiment of the present invention.

An online document creator system 100 includes a hash creator portion 102 and a checksum creator portion 104, a matrix creator portion 106, a combiner portion 108, and a document presenter portion 110.

Hash creator portion 102 creates a document identification string hash for a document. Hash creator portion 102 generates a message digest based upon a received input about the document and a private string key from the user. Non-limiting examples for hash creator portion 102 include SHA-1, SHA-2, SHA-3, SHA-256, SHA-384 and SHA-512, Whirlpool, MD5, Bcrypt, Scrypt, etc. In general, it is computationally infeasible to find an input corresponding to a given message digest. Additionally, a change in an input will, with a high probability, result in a different message digest.

Checksum creator portion 104 creates a checksum. A checksum is a fixed-sized datum computed from a block of digital data. In an embodiment of the present invention, a checksum may be generated by hashing the document identification string with a unique key. The first four digits of this new hash are appended to the identification string. In some embodiments fewer or more digits may be used. For verification of the checksum, the appended digits are stripped from the document identification string, the hashing of the stripped documentation string with the unique key is repeated, and the striped digits and the repeated hashing are compared. If the digits match, the checksum is confirmed. In alternate embodiments, non-limiting examples for checksum creator portion 104 include two's complement and Cyclical Redundancy Check (CRC). In alternate embodiments, a checksum may not be included with the document identification string.

Matrix creator portion 106 creates a data matrix. A data matrix is a two-dimensional matrix barcode consisting of block and white “cells” or modules. Non-limiting examples of shapes for a data matrix includes square and rectangular.

Combiner portion 108 combines a document with a data matrix.

Document presenter portion 110 presents a document for viewing and/or printing.

Hash creator portion 102 receives information from a document 112 and from a unique key 114. Non-limiting examples for document 112 include driver license, birth certificate and passport. Checksum creator portion 104 receives information from hash creator portion 102 and unique key 114. Matrix creator portion 106 receives information from checksum creator portion 104 and document identification string. Combiner receives information from matrix creator portion 106 and document 112. Document presenter portion 110 receives information from combiner and generates a document/identifier portion 116. Document/identifier portion 116 includes the initial information provided by document 112 plus data matrix information.

When document/identifier portion 116 is created, the document and document identification string may be stored on a server. The unique encoding information may be maintained as a secret by the entity. In other embodiments, the processing may be hosted via a server to which the information is communicated. The processed information may then be provided to the entity and stored via a server.

In some embodiments, information associated with document 112 may be entered manually. As a non-limiting example, the number of digits from the hashing of the document identification string to be used in the checksum may be entered.

The format of the hash and associated identifying information is customizable with respect to length as specified by the entity. The unique identifying parameter is secure maintained as the unique key is needed for decryption.

A checksum is used to prevent database queries when the checksum is not correct per the associated document. Furthermore, as a non-limiting example, checksum may be configured as four characters. Furthermore, the checksum may be used to verify the integrity of a request for information prior to performing a search of the database. Furthermore, checksum verification prior to document retrieval aids in preventing brute force attacks on the server(s).

An additional code may be incorporated in order to uniquely identify an entity. As a non-limiting example, the code may be appended to the initial portion of document/identifier portion 116. Furthermore, as a non-limiting example, the code may be alphanumeric and generated per customer specification.

Data matrices may be generated for the code and associated document. Non-limiting examples of data matrices comprise 1d and 2d bar codes or any matrix that may be scanned and decoded and may contain error correction capabilities. Furthermore, redundant codes may be used to create additional secure hashes via an alternate string. Furthermore, in other embodiments, shorter strings may be configured for use with bar codes. Non-limiting examples for bar code denominations include 1d 39 and 128 and 2d barcodes such as Aztex code, EZCode, MaxiCode.

In operation, hash creator portion 102 receives document 112 and a unique key and generates a hash. Checksum creator portion 104 receives hash and generates a checksum. Matrix creator portion 106 receives checksum and document identification string in order to generate a data matrix. Combiner portion 108 receives document 112 and a data matrix for creating a combined document. Document presenter portion 110 presents document/identifier portion 116 for viewing.

FIG. 1 illustrates an example online document creator system for receiving a document and creating a hash for the received document, creating checksum from hash and unique key, generating data matrix from checksum and document, combining document and data matrix and generating a document combining the original document plus the data matrix.

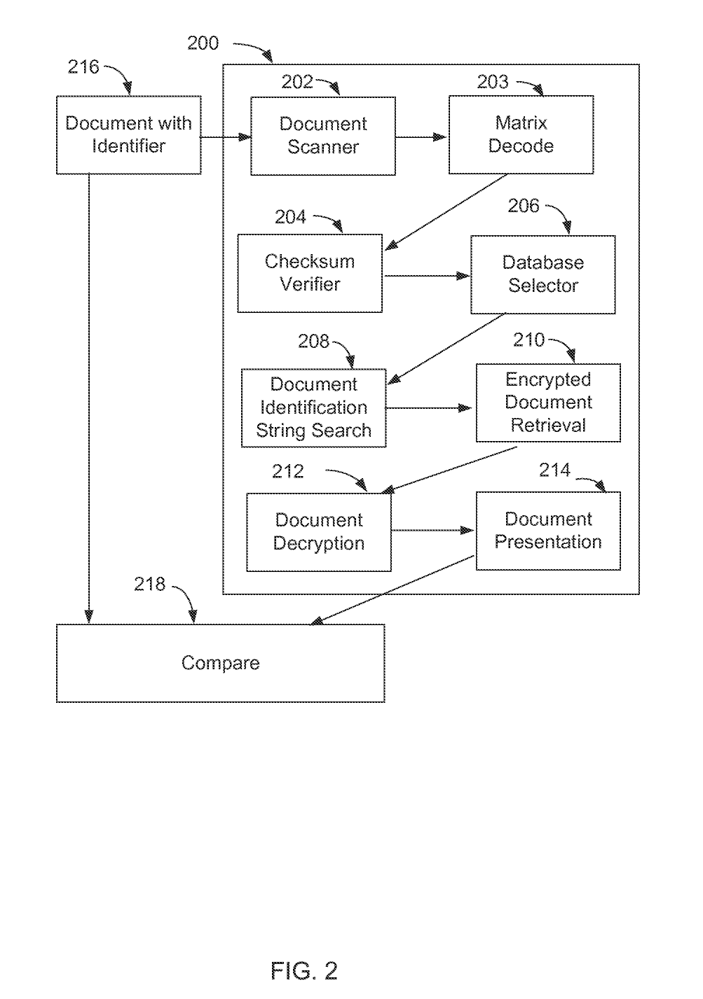

FIG. 2 illustrates an example online document verifier system, in accordance with an embodiment of the present invention.

An online document verifier system 200 includes a document scanner portion 202, a matrix decode 203, a checksum verifier portion 204, a database selector portion 206, a document identification string search portion 208, an encrypted document retrieval portion 210, a document decryption portion 212 and a document presentation portion 214. In some embodiments, the documents retrieved are not encrypted and document decryption portion 212 is not included.

Document scanner portion 202 receives information from a document containing an identifier noted as a document/identifier 216. Matrix decode 203 receives information from document scanner portion 202. Checksum verifier portion 204 receives information from matrix decode 203. Database selector portion 206 receives information and document identification string from checksum verifier portion 204. Document identification string search portion 208 receives information from database selector portion 206. Encrypted document retrieval portion 210 receives information from document identification string search portion 208. Document decryption portion 212 receives information from encrypted document retrieval portion 210 and document presentation receives information from document decryption portion 212.

Document scanner portion 202 scans a document in order to convert the document to a digital representation of the document.

Matrix decode 203 converts matrix image to data or information.

Checksum verifier portion 204 verifies the checksum associated with the decoded data.

Database selector portion 206 selects a database for search based upon the document identification string.

Document identification string search portion 208 performs a search of the selected database for the checksum.

Encrypted document retrieval portion 210 retrieves a document from the selected database with associated with the checksum. The document may be encrypted or unencrypted.

Document decryption portion 212 decrypts the document, if needed, to generate an unencrypted version of the document.

Document presentation portion 214 presents or communicates the unencrypted document.

For verification, a document is scanned or recreated manually. Non-limiting examples of devices used for verification include smartphone application and mobile computing device or barcode scanner equipment. Document creators may select the level of verification associated with public use and may select a multiplicity of levels associated with respective users.

In some embodiments, an entity may charge a fee for access to information provided by server(s).

Initially, the received information is processed for checksum verification. For a correct checksum, a database associated with the document identification string is selected. A search of the database is performed for the document identification string. If the document identification string is found, then the associated information is decrypted, if needed, and retrieved. Dependant upon the level of access associated with the user, the information may be presented to a user. As a non-limiting example, the presentation of the retrieved, decrypted and presented documents may have a similar form as the initial document to aid in performing a comparison. Furthermore, the information may be presented in an image format in order to reduce opportunities for misappropriation of the information.

As a non-limiting example, a driver license may be processed in order to prevent identity theft. Non-limiting examples for information which may be verified include name, identification parameter, date of birth and image of associated person. As another non-limiting example, an entity selling liquor may process a driver license in order to verify the age of a person. Furthermore, an entity may process a driver license in order to verify the image on the presented document matches the authentic image. Furthermore, a difference between the presented document and the authentic document may be detected for purposes of verification.

As another non-limiting example, birth certifications may be verified for authenticity using the issuing entities public key. Furthermore, information associated with the requesting entity may be determined such as date of issue and entity issued. Furthermore, the information in the presented document may be verified for authenticity.

As another non-limiting example, public and private schools perform verification of transcripts. Furthermore, a student may use a single transcript for transmission to schools, potential employers, etc. as opposed to transmitting a multiplicity of transcripts to the various entities. Furthermore, the transcripts may be verified for authenticity.

In operation, document scanner portion 202 receives and scans document from document/identifier 216. Matrix decode 203 receives scanned document and converts matrix image to data or information. Checksum verifier portion 204 verifies the checksum associated with the decoded data or information. Database selector portion 206 selects a database for searching based upon the received document identification string. Document identification string search portion 208 searches selected database for checksum. Encrypted document retrieval portion 210 retrieves encrypted document from selected database associated with document identification string. Document decryption portion 212 decrypts encrypted information associated with retrieved document, if needed. Document presentation portion 214 receives unencrypted information and communicates or presents the information for processing or viewing. A compare 218 performs a comparison between document/identifier 216 and the unencrypted document provided by document presentation portion 214. Compare 218 may be performed manually by a person or programmatically by a computing device (not shown).

FIG. 2 illustrates an example online document verifier system where a document with an identifier is scanned, decoded and checksum verified. Furthermore, a database is selected based upon document identification string, the selected database searched for a document identification string, encrypted document retrieved based upon checksum, retrieved document is decrypted, if needed, and decrypted document is communicated or presented for viewing.

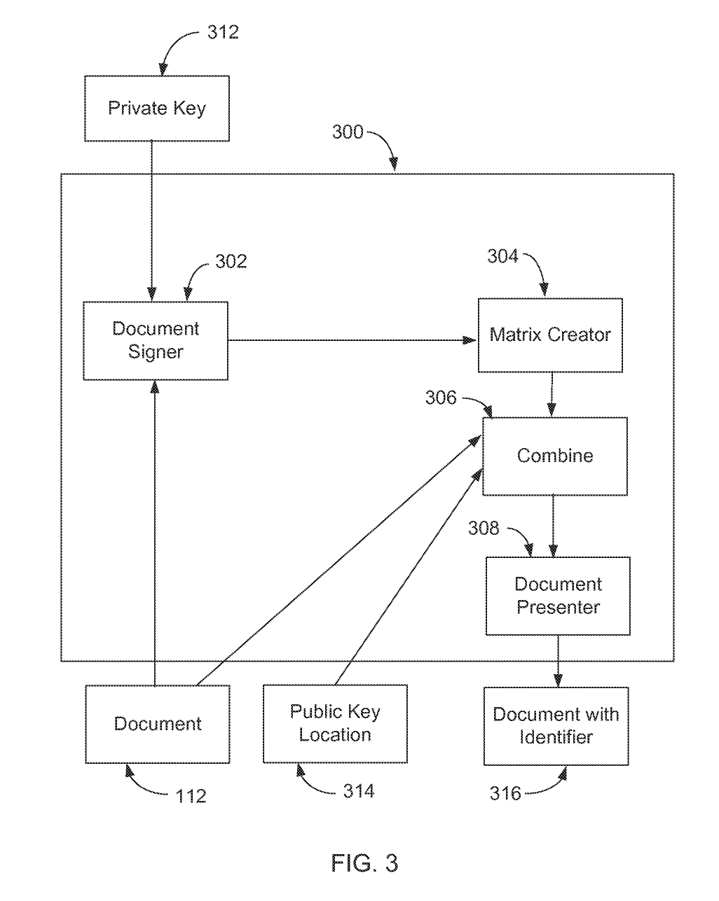

FIG. 3 illustrates an example document creator system for use with offline verification, in accordance with an embodiment of the present invention.

An offline document creator system 300 includes a document signer portion 302, a matrix creator portion 304, a combine portion 306 and a document presenter portion 308.

Document signer portion 302 receives information from a private key 312 and document 112. Matrix creator portion 304 receives information (signature) from document signer portion 302. Combine portion 306 receives information from matrix creator portion 304 and document 112. Document presenter portion 308 receives information from combine portion 306.

Document signer portion 302 performs signing or encryption of received information based upon a private key 312.

Matrix creator portion 304 creates a matrix image based upon received information.

Combine portion 306 combines matrix information and document information.

Document presenter portion 308 presents or communicates information for viewing or processing.

For offline verification, the entity securing the document generates a signed message with the document details. As a non-limiting example, the signed message may be created via GNU Privacy Guard (GPG). The signed message is combined with the document to create a second document.

In operation, document signer portion 302 receives document 112 and private key 312 and encrypts document 112 based upon private key 312. Matrix creator portion 304 creates a matrix image based upon received encrypted information. Combine portion 306 combines signed information and document into a document or data set. Document presenter portion 308 presents or communicates combined document with identifier and public key location as noted by a document/identifier 316.

FIG. 3 illustrates an example document creator system for use with offline verification where an encrypted document is created from a document and a private key, encrypted document is converted to matrix image, matrix image, document and public location are combined and presented to form a document with identifier location.

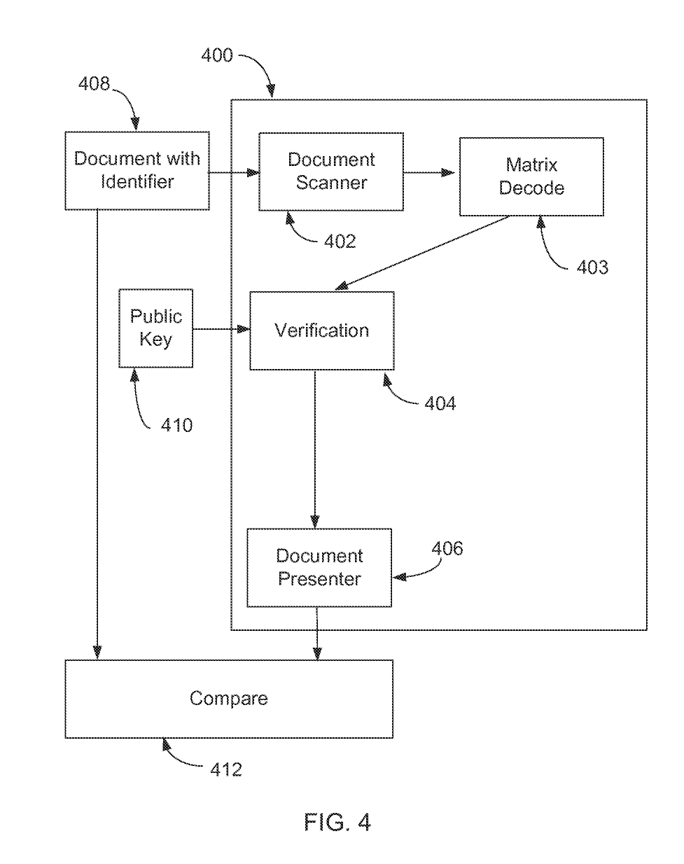

FIG. 4 illustrates an example offline document verifier system, in accordance with an embodiment of the present invention.

An offline document verifier system 400 includes a document scanner portion 402, a matrix decode portion 403, a verification portion 404 and a document presenter portion 406.

Document scanner portion 402 receives document with identifier from a document/identifier portion 408. Matrix decode portion 403 receives information from document scanner portion 402. Verification portion 404 receives information from the matrix decode portion 403 and the Public Key 410. Document presenter portion 406 receives information from verification portion 404.

Document scanner portion 402 received and scans a document.

Matrix decode portion 403 converts a matrix image to a digital representation of the information associated with the matrix image.

Verification portion 404 receives a scanned document and a public key 410 and performs verification of the signed information.

Document presenter portion 406 presents or communicates if the signed information is authentic or not and the data in the signature for comparison.

For offline verification, an application may use stored public keys for document verification. Furthermore, database associated with offline storage may be updated with keys and may provide a centralized and secure location for storing public keys.

In operation, document scanner portion 402 receives a document containing an identifier and converts the document to a digital representation. Matrix decode portion 403 converts matrix image associated with scanned document to a digital representation of the information associated with the matrix image. Verification portion 404 receives the digital representation from matrix decode portion 403 and public key 410 and verifies the signed information. Document presenter portion 406 displays the authenticity of the signature and presents or communicates the information from the signature for viewing or processing. A compare 412 compares the signed document information with the physical document.

FIG. 4 illustrates an example offline document verifier system where a received document is scanned, verified and presented for viewing.

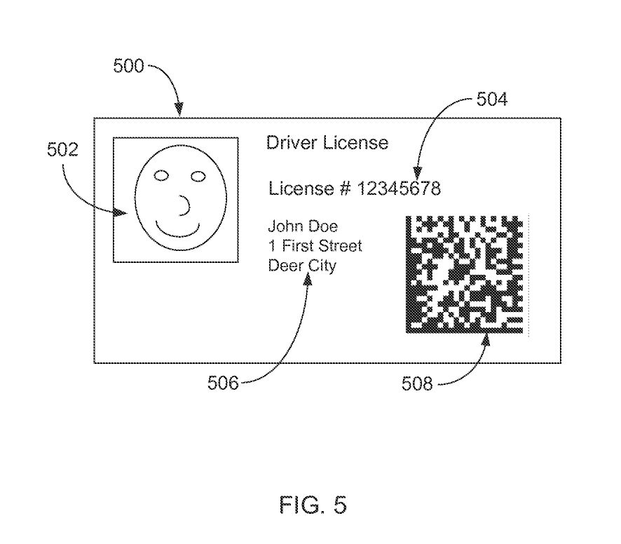

FIG. 5 illustrates an example document, in accordance with an embodiment of the present invention.

A document 500 includes a picture 502, an identification number 504, an address 506 and a matrix image 508. Some embodiments may not include a picture and address and may include various other types of information. Some embodiments may also include the document identification string along with the matrix image so that the data matrix could be typed in manually. In some embodiments, the document identification string may also be the identification number. In some embodiments, the matrix image may not be included and only the document identification string would be used.

Non-limiting examples for document 500 include driver license, birth certificate and passport.

Document 500 provides identification information.

Picture 502 provides an image of a person associated with document 500.

Identification number 504 provides a unique identifier associated with document 500.

Address 506 provides address information for a person associated with document 500.

Matrix image 508 provides information associated with document 500 for verifying information associated with document 500 and verifying person associated with document 500.

FIG. 5 illustrates an example document where information is presented with an associated matrix image used for verification of document and associated person.

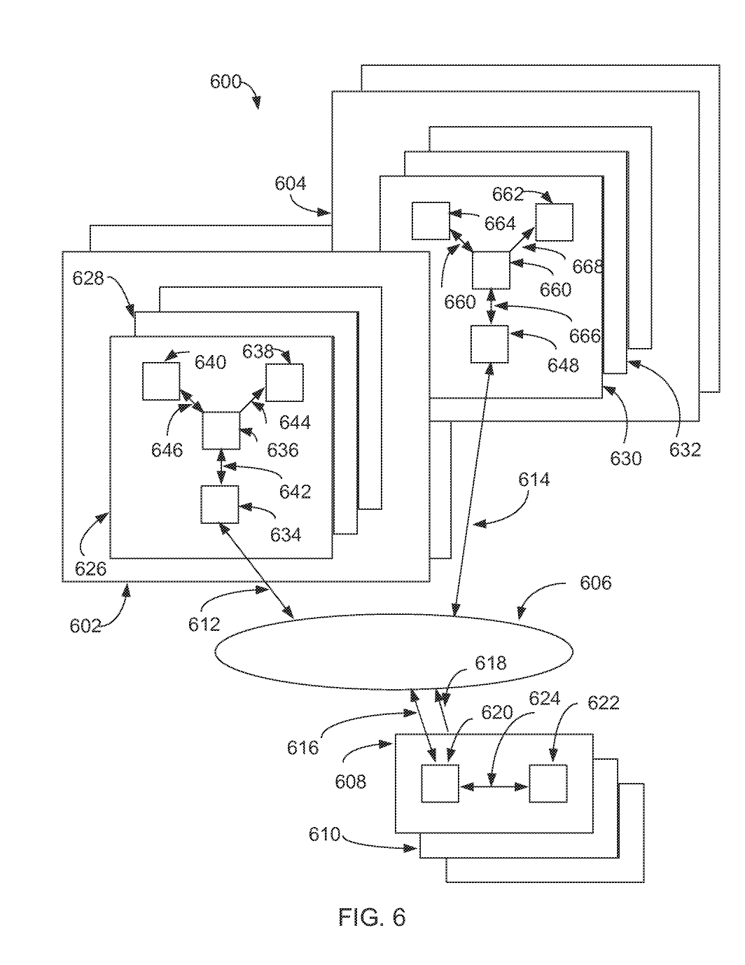

FIG. 6 illustrates a block diagram depicting a conventional client/server communication system.

A communication system 600 includes a multiplicity of networked regions with a sampling of regions denoted as a network region 602 and a network region 604, a global network 606 and a multiplicity of servers with a sampling of servers denoted as a server device 608 and a server device 610.

Network region 602 and network region 604 may operate to represent a network contained within a geographical area or region. Non-limiting examples of representations for the geographical areas for the networked regions may include postal zip codes, telephone area codes, states, counties, cities and countries. Elements within network region 602 and 604 may operate to communicate with external elements within other networked regions or within elements contained within the same network region.

In some implementations, global network 606 may operate as the Internet. It will be understood by those skilled in the art that communication system 600 may take many different forms. Non-limiting examples of forms for communication system 600 include local area networks (LANs), wide area networks (WANs), wired telephone networks, cellular telephone networks or any other network supporting data communication between respective entities via hardwired or wireless communication networks. Global network 606 may operate to transfer information between the various networked elements.

Server device 608 and server device 610 may operate to execute software instructions, store information, support database operations and communicate with other networked elements. Non-limiting examples of software and scripting languages which may be executed on server device 608 and server device 610 include C, C++, C# and Java.

Network region 602 may operate to communicate bi-directionally with global network 606 via a communication channel 612. Network region 604 may operate to communicate bi-directionally with global network 606 via a communication channel 614. Server device 608 may operate to communicate bi-directionally with global network 606 via a communication channel 616. Server device 610 may operate to communicate bi-directionally with global network 606 via a communication channel 618. Network region 602 and 604, global network 606 and server devices 608 and 610 may operate to communicate bi-directionally and also communicate bi-directionally with other networked device located within communication system 600.

Server device 608 includes a networking device 620 and a server 622. Networking device 620 may operate to communicate bi-directionally with global network 606 via communication channel 616 and with server 622 via a communication channel 624. Server 622 may operate to execute software instructions and store information.

Network region 602 includes a multiplicity of clients with a sampling denoted as a client 626 and a client 628. Client 626 includes a networking device 634, a processor 636, a GUI 638 and an interface device 640. Non-limiting examples of devices for GUI 638 include monitors, televisions, cellular telephones, smartphones and PDAs (Personal Digital Assistants). Non-limiting examples of interface device 640 include pointing device, mouse, trackball, scanner and printer. Networking device 634 may communicate bi-directionally with global network 606 via communication channel 612 and with processor 636 via a communication channel 642. GUI 638 may receive information from processor 636 via a communication channel 644 for presentation to a user for viewing. Interface device 640 may operate to send control information to processor 636 and to receive information from processor 636 via a communication channel 646. Network region 604 includes a multiplicity of clients with a sampling denoted as a client 630 and a client 632. Client 630 includes a networking device 648, a processor 650, a GUI 652 and an interface device 654. Non-limiting examples of devices for GUI 638 include monitors, televisions, cellular telephones, smartphones and PDAs (Personal Digital Assistants). Non-limiting examples of interface device 640 include pointing devices, mousse, trackballs, scanners and printers. Networking device 648 may communicate bi-directionally with global network 606 via communication channel 614 and with processor 650 via a communication channel 656. GUI 652 may receive information from processor 650 via a communication channel 658 for presentation to a user for viewing. Interface device 654 may operate to send control information to processor 650 and to receive information from processor 650 via a communication channel 660.

For example, consider the case where a user interfacing with client 626 may want to execute a networked application. A user may enter the IP (Internet Protocol) address for the networked application using interface device 640. The IP address information may be communicated to processor 636 via communication channel 646. Processor 636 may then communicate the IP address information to networking device 634 via communication channel 642. Networking device 634 may then communicate the IP address information to global network 606 via communication channel 612. Global network 606 may then communicate the IP address information to networking device 620 of server device 608 via communication channel 616. Networking device 620 may then communicate the IP address information to server 622 via communication channel 624. Server 622 may receive the IP address information and after processing the IP address information may communicate return information to networking device 620 via communication channel 624. Networking device 620 may communicate the return information to global network 606 via communication channel 616. Global network 606 may communicate the return information to networking device 634 via communication channel 612. Networking device 634 may communicate the return information to processor 636 via communication channel 642. Processor 636 may communicate the return information to GUI 638 via communication channel 644. User may then view the return information on GUI 638.

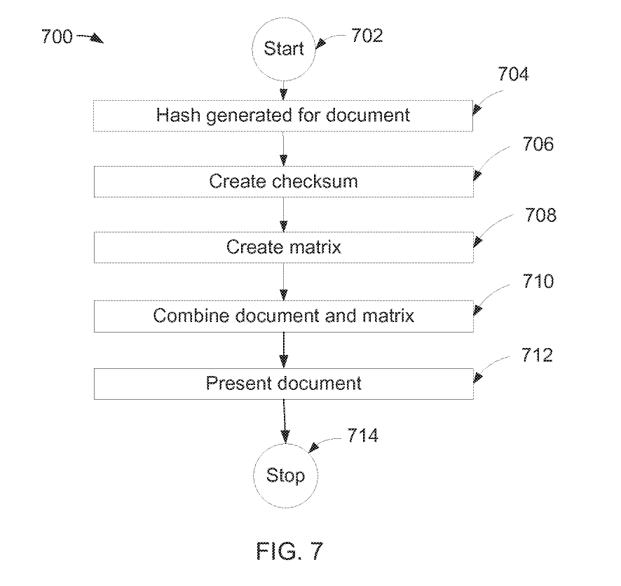

FIG. 7 illustrates an example method for online document creation as described with reference to FIG. 1, in accordance with an embodiment of the present invention.

A method 700 initiates in a step 702.

Then in a step 704, a hash is generated for a document.

Hash creator portion 102 (FIG. 1) receives document information and a unique string key 112 (FIG. 1) and creates a document identification string based upon the hash.

As an example, digital information associated with driver license (e.g. document 500 (FIG. 5)) is provided to hash generator for creating a document identification string.

Referring back to FIG. 7, then in a step 706, a checksum is created.

Checksum creator portion 104 (FIG. 1) receives document identification string from hash creator portion 102 (FIG. 1) and unique key 114 (FIG. 1) and generates a checksum.

Referring back to FIG. 7, then in step 708, a matrix is created.

Matrix creator portion 106 (FIG. 1) receives document identification string and checksum from checksum creator portion 104 (FIG. 1) and document identification string in order to generate a matrix (e.g. matrix image 508 (FIG. 5)).

Referring back to FIG. 7, then in a step 710, document and matrix are combined.

Combiner portion 108 (FIG. 1) receives matrix (e.g. matrix image 508 (FIG. 5)) and document 112 (FIG. 1) to form a combined document with matrix (e.g. document 500 (FIG. 5)).

Referring back to FIG. 7, then in a step 712, document with matrix (e.g. document 500 (FIG. 5)) is presented and/or communicated via document presenter portion 110 (FIG. 1). As an example, document may be presented via GUI 638 (FIG. 6).

Referring back to FIG. 7, then in a step 712, method 700 terminates.

FIG. 7 illustrates an example method for online document creation as described with reference to FIG. 1 where a matrix is generated for a document and combined with document via online.

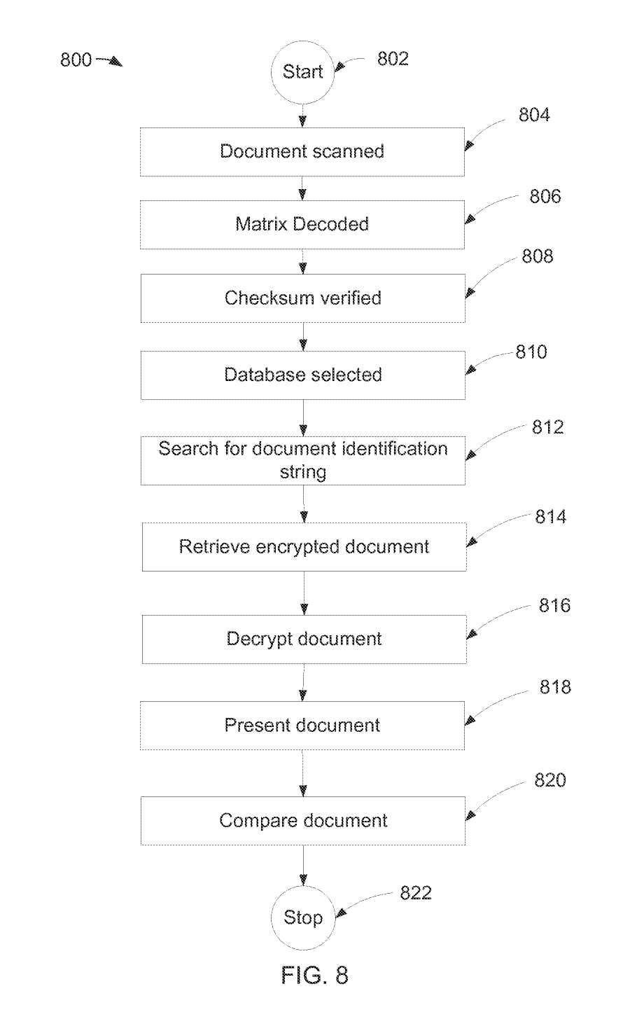

FIG. 8 illustrates an example method for online document verification as described with reference to FIG. 2, in accordance with an embodiment of the present invention.

A method 800 initiates in a step 802.

Then in a step 804, a document scanned.

Document scanner portion 202 (FIG. 2) receives document with identifier from document/identifier 216 (FIG. 2) and generates a digital representation of document/identifier 216 (FIG. 2).

As an example, a driver license (e.g. document 500 (FIG. 5)) containing a matrix image (e.g. matrix image 508 (FIG. 5)) is scanned.

Referring back to FIG. 8, then in a step 806, a matrix is decoded.

Matrix decode 203 (FIG. 2) receives a digital representation of a document with a matrix image from document scanner portion 202 (FIG. 2) and decodes matrix image into a document identification string.

Referring back to FIG. 8, then in a step 808, a checksum is verified for the document identification string.

Checksum verifier portion 204 (FIG. 2) verifies a checksum.

Referring back to FIG. 8, then in a step 810, a database is selected.

Database selector portion 206 (FIG. 2) selects a database associated with document identification string.

Referring back to FIG. 8, then in a step 812, a search for a document associated with the document identification string is performed.

Document identification string search portion 208 (FIG. 2) performs a search for a document associated with the received document identification string.

Referring back to FIG. 8, then in a step 814, an encrypted or unencrypted document is retrieved from the selected database associated with the received document identification string.

Encrypted document retrieval portion 210 (FIG. 2) retrieves an encrypted or unencrypted document from the selected database associated with the received document identification string.

Referring back to FIG. 8, then in a step 816, the retrieved encrypted document is decrypted, if needed.

Document decryption portion 212 (FIG. 2) decrypts the encrypted document, if needed.

Referring back to FIG. 8, then in a step 818, the decrypted document is presented and/or communicated.

Document presentation portion 214 (FIG. 2) presents the decrypted document for viewing or processing.

Referring back to FIG. 8, then in a step 820, the decrypted document is compared to the received document.

Compare 218 performs a comparison between the received document (e.g. document/identifier 216 (FIG. 2)) and the presented document (e.g. document presentation portion 214 (FIG. 2)) in order to verify if the received document is authentic.

For example, a driver license may be verified as authentic.

Referring back to FIG. 8, then in a step 820, method 800 terminates execution.

FIG. 8 illustrates an example method for online document verification as described with reference to FIG. 2 where a document is received, processed and compared for determining authenticity via online.

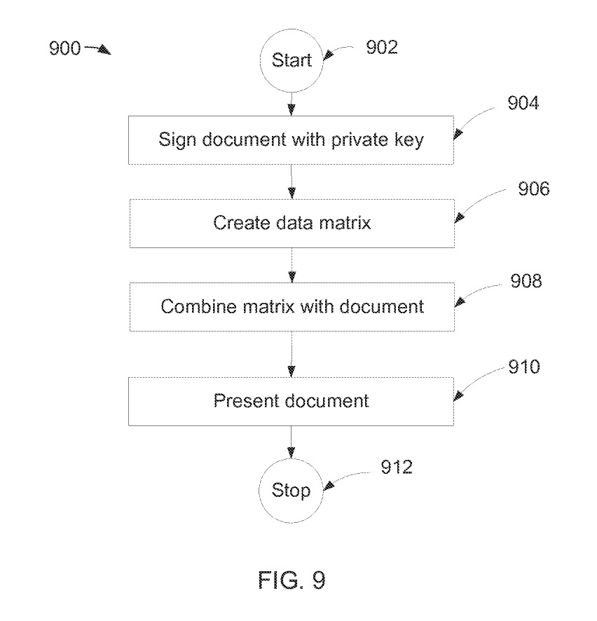

FIG. 9 illustrates an example method for document creation associated with offline verification as described with reference to FIG. 3, in accordance with an embodiment of the present invention.

A method 900 initiates in a step 902.

Then in a step 904, a document is signed.

Document signer portion 302 (FIG. 3) receives document 112 (FIG. 3) and private key 312 (FIG. 3) and generates a signed document.

Referring back to FIG. 9, then in a step 906, a matrix is created.

Matrix creator portion 304 (FIG. 3) receives signed information and generates a matrix.

Referring back to FIG. 9, then in a step 908 document and matrix are combined.

Combine portion 306 (FIG. 3) combines document 112 (FIG. 3) and matrix generated by matrix creator portion 304 (FIG. 3).

Referring back to FIG. 9, then in a step 910, generated document is presented or communicated.

Document presenter portion 308 (FIG. 3) presents or communicates document/identifier 316 (FIG. 3). As an example, document/identifier may be presented via GUI 638 (FIG. 6).

Referring back to FIG. 9, then in a step 912, execution of method 900 terminates.

FIG. 9 illustrates an example method for document creation associated with offline verification as described with reference to FIG. 3 where a document is received and processed offline for creating a document.

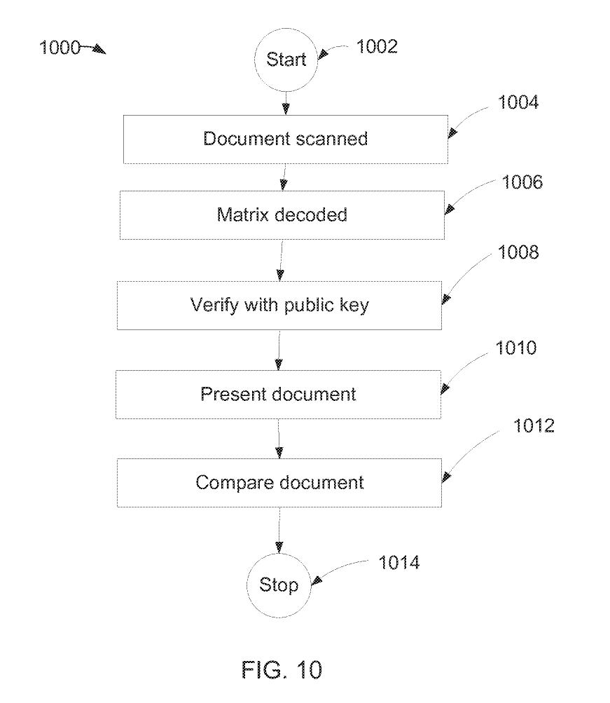

FIG. 10 illustrates an example method for offline document verification as described with reference to FIG. 4, in accordance with an embodiment of the present invention.

A method 1000 initiates in a step 1002.

Then in a step 1004, a document is scanned.

Document scanner portion 402 (FIG. 4) receives document/identifier portion 408 and generates a digital representation of document.

Referring back to FIG. 10, then in a step 1006, matrix is decoded.

Matrix decode portion 403 (FIG. 4) receives scanned document from document scanner portion 402 (FIG. 4) and decodes a matrix.

Referring back to FIG. 10, then in a step 1008, decoded information is verified with a public key.

Verified portion 404 (FIG. 4) receives decoded matrix from matrix decode portion 403 (FIG. 4) and uses public key 410 (FIG. 4) to perform verification.

Referring back to FIG. 10, then in a step 1010, document and authenticity are presented for viewing and/or processing.

Document presenter portion 406 (FIG. 4) receives and presents document.

Referring back to FIG. 10, then in a step 1012, verified document information is compared to initial document for verification of authenticity.

Compare 412 (FIG. 4) performs a comparison of verified document information received from document presenter portion 406 (FIG. 4) and document/identifier portion 408 (FIG. 4) in order to verify that document/identifier portion 408 (FIG. 4) is an authentic document.

For example, a birth certificate may be verified as authentic.

Referring back to FIG. 10, then in a step 1014, execution of method 1014 terminates.

FIG. 10 illustrates an example method for offline document verification as described with reference to FIG. 4 where a document is received and processed and verification for authenticity is performed via offline.

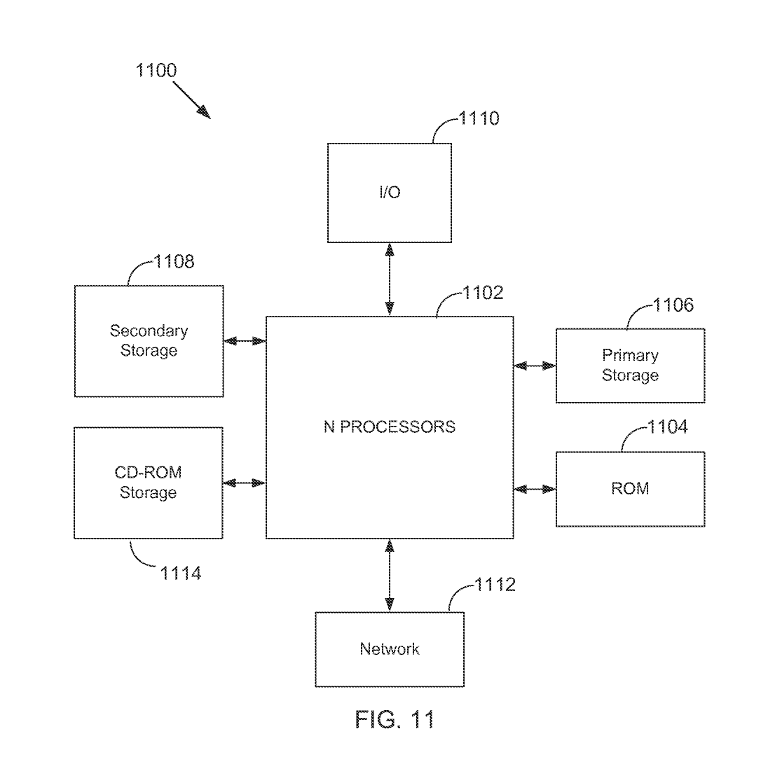

FIG. 11 illustrates a typical computer system that, when appropriately configured or designed, may serve as a computer system 1100 for which the present invention may be embodied.

Computer system 1100 includes a quantity of processors 1102 (also referred to as central processing units, or CPUs) that may be coupled to storage devices including a primary storage 1106 (typically a random access memory, or RAM), a primary storage 1104 (typically a read-only memory, or ROM). CPU 1102 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 1104 acts to transfer data and instructions uni-directionally to the CPU and primary storage 1106 typically may be used to transfer data and instructions in a bi-directional manner. The primary storage devices discussed previously may include any suitable computer-readable media such as those described above. A mass storage device 1108 may also be coupled bi-directionally to CPU 1102 and provides additional data storage capacity and may include any of the computer-readable media described above. Mass storage device 1108 may be used to store programs, data and the like and typically may be used as a secondary storage medium such as a hard disk. It will be appreciated that the information retained within mass storage device 1108, may, in appropriate cases, be incorporated in standard fashion as part of primary storage 1106 as virtual memory. A specific mass storage device such as a CD-ROM 1114 may also pass data uni-directionally to the CPU.

CPU 1102 may also be coupled to an interface 1110 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1102 optionally may be coupled to an external device such as a database or a computer or telecommunications or internet network using an external connection shown generally as a network 1112, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers and global network.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of electronic document verification according to the present invention will be apparent to those skilled in the art. The invention has been described above by way of illustration, and the specific embodiments disclosed are not intended to limit the invention to the particular forms disclosed. For example, the particular implementation of the GUIs may vary depending upon the particular type computing device used. The computing devices described in the foregoing were directed to mobile computing implementations; however, similar techniques using laptop computing implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A computer implemented method comprising the steps of:
processing a document using a key to generate a document identification;
generating a matrix using data from the document identification, the matrix comprising a scannable element; and
combining the matrix and the document to form a second document in which a verification of an authenticity of the second document is performed using at least the matrix.

2. The method as recited in claim 1, in which said processing further comprises hashing the document.

3. The method as recited in claim 1, further comprising the steps of generating a checksum and appending the checksum to the document identification.

4. The method as recited in claim 3, in which said generating a checksum further comprises hashing the document identification.

5. The method as recited in claim 4, in which said appending further comprises selecting a portion of the hashed document identification for appending.

6. The method as recited in claim 1, further comprising the step of storing the document and document identification in a database.

7. The method as recited in claim 1, further comprising the steps of scanning the second document to retrieve the scannable element and decoding the scannable element.

8. The method as recited in claim 7, further comprising the step of verifying the authenticity of the second document using at least the decoded scannable element.

9. The method as recited in claim 6, in which the database is searchable for verifying the authenticity of the second document.

10. A system comprising:
a processing unit being configured to process a document using a key to generate a document identification;
a matrix unit being configured to generate a matrix using data from the document identification, the matrix comprising a scannable element; and
a combining unit being configured to combine the matrix and the document to form a second document in which a verification of an authenticity of the second document is performed using at least the matrix.

11. The system as recited in claim 10, in which said processing unit is further configured to hash the document.

12. The system as recited in claim 10, further comprising a generating unit being configured to generate a checksum and append the checksum to the document identification.

13. The system as recited in claim 12, in which said generating unit is further configured to hash the document identification to generate the checksum.

14. The system as recited in claim 13, in which said generating unit is further configured to select a portion of the hashed document identification for appending.

15. The system as recited in claim 10, further comprising a storing unit being configured to store the document and document identification in a database.

16. The system as recited in claim 10, further comprising a scanning unit being configured to scan the second document to retrieve the scannable element for decoding the scannable element.

17. The system as recited in claim 16, further comprising a verification unit being configured to verify the authenticity of the second document using at least a decoded scannable element.

18. The system as recited in claim 15, in which the database is searchable for verifying the authenticity of the second document.

19. A non-transitory program storage device readable by a machine tangibly embodying a program of instructions executable by the machine to perform a method for document verification, comprising computer code for:
processing a document using a key to generate a document identification;
generating a matrix using data from the document identification, the matrix comprising a scannable element; and
combining the matrix and the document to form a second document in which a verification of an authenticity of the second document is performed using at least the matrix.

20. The program storage device as recited in claim 19, further comprising computer code for:
hashing the document to generate the document identification;
generating a checksum by hashing the document identification, selecting a checksum portion of the hashed document identification and appending the checksum portion to the document identification;
storing the document and document identification in a database;
scanning the second document to retrieve the scannable element;
decoding the scannable element to retrieve the document identification and the checksum portion;
verifying the retrieved document identification by hashing the retrieved document identification and comparing a portion of the hashed retrieved document with the retrieved checksum portion;
searching the database using the verified retrieved document identification to retrieve the stored document; and
presenting the retrieved stored document for comparison to the second document to verify the authenticity of the second document.
